(19) United States
(12) Patent Application Publication
(10) Pub. No.: US 2021/0331607 A1
(43) Pub. Date: Oct. 28, 2021

(54) Child Seat Safety System

(71) Applicant: Cheryl Yoder, Shelbyville, TN (US)

(72) Inventor: Cheryl Yoder, Shelbyville, TN (US)

(21) Appl. No.: 16/991,172

(22) Filed: Aug. 12, 2020

Related U.S. Application Data
(60) Provisional application No. 63/015,985, filed on Apr. 27, 2020.

(51) Int. Cl. B60N 2/28; G08B 21/02; G08B 25/00; G07C 9/00

(52) U.S. Cl. CPC B60N 2/2812; G08B 21/0277; G07C 2009/00984; G08B 25/008; G07C 9/00182; G08B 21/0211

(57) ABSTRACT

A safety system for use with a car seat. The safety system protects a child from inadvertently being left alone in a locked car seat. The child seat safety system integrates a fob mechanism with a buckle of a restraint component capable of sending an alert to a mobile application when a parent or caregiver leaves the vicinity of the car seat while the buckle is armed. The armed buckle is released when the fob mechanism is inserted into a slot in the buckle. The fob mechanism is in wireless communication with the buckle to sense when the fob mechanism is moved away from the car seat. When a predetermined distance between the buckle and the fob mechanism is sensed, a wireless communication is sent to the mobile application to alert the user.

### CROSS-REFERENCE TO RELATED APPLICATION

The present application claims priority to, and the benefit of, U.S. Provisional Application No. 63/015,985, which was filed on Apr. 27, 2020 and is incorporated herein by reference in its entirety.

### BACKGROUND

The present invention generally relates to a safety system for a car seat, and more specifically to a child seat safety system for alerting a parent that a child is still locked in a car seat. Accordingly, the present specification makes specific reference thereto. However, it is to be appreciated that aspects of the present invention are also equally amenable to other like applications, devices and methods of manufacture.

No matter how responsible a parent or caregiver can be, a child could still be inadvertently left in a car seat in a vehicle. If left unattended in a hot car, the child could suffer serious injury or even death. Heat stroke, or hyperthermia, is the leading cause of non-car crash vehicular death in the United States for children. Children's bodies heat up much more quickly than adults, and cars heat up very quickly in the sun. This leaves children very vulnerable to if accidently left alone in the car seat.

A properly fitted and installed child car seat can mean the difference between life or death if the child is riding in a car involved in a motor vehicle accident. The seats are designed to absorb impacts that would otherwise be transferred to the child causing bodily harm. The straps and buckles, or harness system are designed to prevent the child from slipping or moving into a dangerous position that could block their airway. Just like seatbelts save the lives of adults, car seats save the lives of infants and children.

Car seats are designed to be installed in the back seat of most vehicles. The back seat has been shown to be the safest place in a car in the event of an accident. Unfortunately, the back seat is not in the parent's or caregivers' line of sight. They can check the mirror from time to time, but do not have the child in mind constantly as driving requires most of their attention. Children often fall asleep while riding in vehicles. When the trip is over, an older child or an awake child will usually provide a warning that they are still in the car. Infants and sleeping children will not provide that warning. The parent may be easily distracted and may easily forget the child is still locked in the car seat as they leave the vehicle.

As mentioned before, a properly designed car seat restraint system is designed to prevent the child from moving very much. As such, even an older child cannot easily manipulate the unlocking mechanism and navigate an exit from the car seat. A younger child or infant has no capability to do this. Additionally, as the car heats up, the hyperthermia makes the child drowsier and less likely to wake up thereby adding to the danger. By the time the parent or caregiver recognizes the lapse, it can be too late.

In this manner, the improved safety system of the present invention accomplishes all of the forgoing objectives, thereby providing an easy solution to keep children in car seats safe. A primary feature of the present invention is that the system alerts a parent or caregiver when the child has been inadvertently left behind in the vehicle. The safety system ensures that a parent or guardian receives a remote alert when the car seat is locked, and they are a predetermined distance away from the vehicle.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a child seat safety system. The child seat safety system is configured to protect a child from inadvertently being left alone in a locked car seat. The child seat safety system comprises a restraint component adapted for use with a car seat. The car seat may be an infant carrier, a rear facing car seat, a convertible seat, a combination seat, or a booster seat. The car seat may comprise a temperature sensor.

The restraint component is a harness. The harness typically comprises a pair of shoulder and leg straps, a crotch strap, and a buckle. The buckle is configured to secure the pair of shoulder and leg straps to the crotch strap. The buckle comprises a pair of female slots for accepting each male buckle end of the shoulder and leg straps. The shoulder and leg straps engage the buckle to lock the restraint component in a locked position.

The child seat safety system further comprises a fob mechanism. The fob mechanism is configured to arm and disarm the buckle of the restraint component. The fob mechanism comprises a buckle engaging element. The buckle engaging element engages a locking mechanism receiving slot of the buckle. The buckle further comprises a buckle sensor. The buckle sensor is a mechanical or electrical switch that detects when the buckle is locked. The buckle further comprises a buckle transmitter.

The fob mechanism further comprises a fob mechanism transmitter and a fob mechanism receiver. The fob mechanism receiver is in electronic communication with the buckle transmitter. When the buckle sensor detects that the buckle is locked, the buckle transmitter transmits a signal to the fob mechanism receiver indicating that the buckle is locked. The fob mechanism transmitter is typically a Bluetooth® transmitter.

The child seat safety system further comprises a mobile application storable on a mobile electronic device. The mobile application is configured to receive an electronic communication from the fob mechanism once paired. The fob mechanism transmitter sends the electronic communication to the mobile application once the fob mechanism is separated from the restraint component by a preset distance whenever the restraint component is locked and armed. Once the electronic communication is received, the mobile application signals the user with an audible or digital alert indicating that a child has been inadvertently left alone in a locked car seat.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the present invention of a child safety seat system for protecting a child from inadvertently being left alone in a locked car seat in accordance with the disclosed architecture.

FIG. 2 illustrates a perspective view of the child seat safety system of the present invention where the car seat is an infant carrier in accordance with the disclosed architecture.

FIG. 3 illustrates a perspective view of the child seat safety system of the present invention where the car seat is a booster seat in accordance with the disclosed architecture.

FIG. 4 illustrates a close-up perspective view of a restraint component in a locked and armed configuration and a fob mechanism of the child safety seat system of the present invention in accordance with the disclosed architecture.

FIG. 5 illustrates a close-up perspective view of a buckle of the restraint component in an unlocked and disarmed configuration and the fob mechanism of the child safety seat system of the present invention in accordance with the disclosed architecture.

FIG. 6 illustrates an exploded view of the buckle of the restraint component and the fob mechanism of the child safety seat system of the present invention in accordance with the disclosed architecture.

FIG. 7 illustrates a perspective view of a mobile application of the child safety seat system of the present invention alerting a user that the restraint component is still locked and armed after moving a predetermined distance away from the child car seat in accordance with the disclosed architecture.

FIG. 8 illustrates a close-up view of the restraint component of the child safety system of the present invention in the locked and armed configuration in in accordance with the disclosed architecture.

FIG. 9 illustrates a close-up view of the restraint component of the child safety system of the present invention in the unlocked and disarmed configuration in in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a system for providing parents and guardians from accidently leaving a child behind in a vehicle. The system is a wireless alert system comprising a small wireless attachment capable of communicating with a paired smart phone application, functioning as the notification device for the child. The invention includes a specialized unlocking mechanism on a key fob that can be used to release the seatbelt buckle of the car seat thereby reducing the chance of the child being inadvertently left behind in the vehicle. The invention ensures that the parent or guardian does not walk too far away from an unattended child in their car seat, allowing an alert to be continuously sent until reset.

The child safety seat system is a wireless communication tool. The system comprises a physical attachment (e.g. a USB key fob), integrated with Bluetooth® or radiofrequency identification (RFID) technology designed to communicate with a smart phone application. The application can emit an alert received from the physical attachment should the parent or guardian walk too far away from a vehicle with the car seat seatbelt still engaged. When a preset distance is breached, an alert is sent from the device to the application. The car seat may also be equipped with temperature sensors capable of determine the internal temperature of the vehicle. The car seat buckle can only be unlocked using the USB fob mechanism. If the notification is sent from the USB fob, it reminds the parent or guardian to attend to the child in the back seat and promptly remove them from the vehicle.

The “smart” car seat uses a restraint system comprising a shoulder and hip harness that attaches to a crotch strap with a “smart” buckle. A key fob is insertable into the buckle to arm and disarm the buckle. The key fob is configured with an arming and disarming key that can be bypassed via a mobile application. When the child is in the car seat, the restraint system is buckled, and the key fob is removed arming the system. Once armed, the system monitors both the child in the car seat and the ambient temperature in the car.

Once a destination is reached, the key fob is replaced in the buckle and the system is disarmed. If the child is inadvertently left in the car seat, an alert is sent to the mobile application once a pre-set distance is breached. The alert can be repeated at intervals, and an additional alert may be sent to emergency services if the buckle s not disarmed. The buckle is disarmed when the key fob is replaced in the buckle or the system is bypassed via the mobile application.

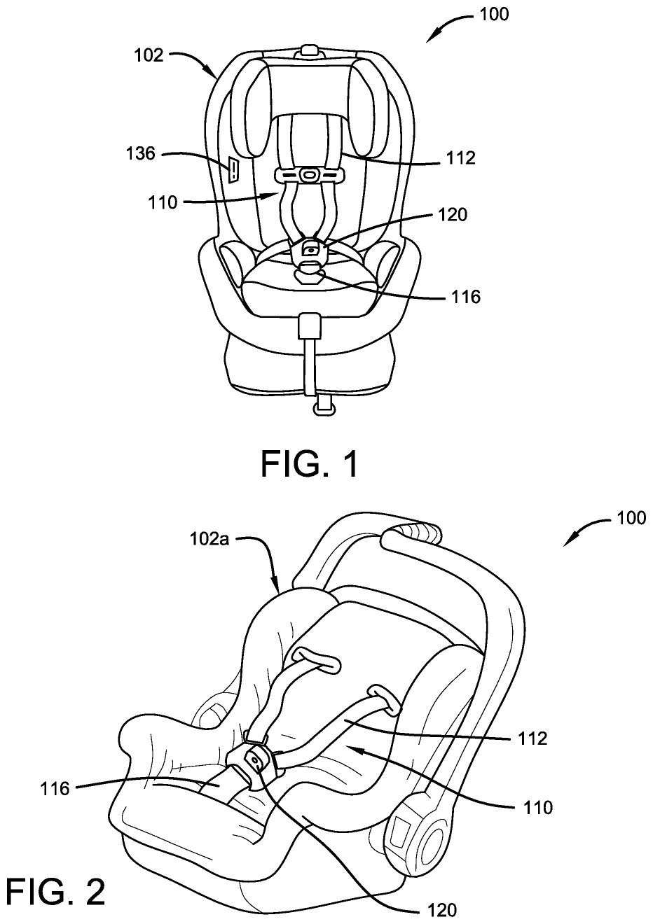

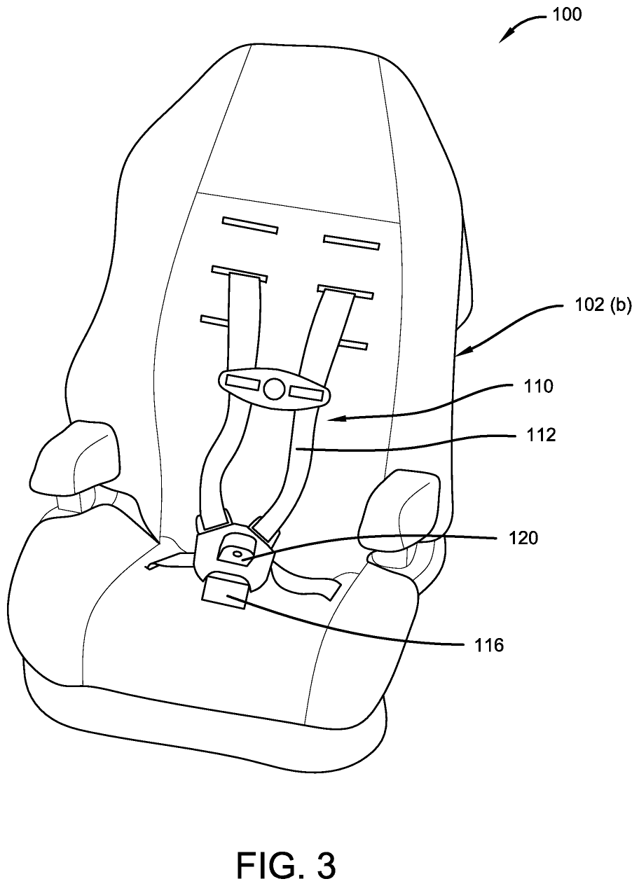

Referring initially to the drawings, FIGS. 1-9 illustrates a child seat safety system 100. The child seat safety system 100 protects a child from inadvertently being left alone in a locked car seat. The child seat safety system 100 comprises a car seat 102. The car seat 102 may be a child car seat 102 as illustrated in FIG. 1, an infant carrier car seat 102(a) as illustrated in FIG. 2, a child booster seat 102(b) as illustrated in FIG. 3, a rear facing car seat, a convertible seat, a combination car seat, or any other child safety seat adapted for use in a vehicle. The child car seat 102 is constructed to restrain and protect a child in a vehicle in the event of a motor vehicle accident.

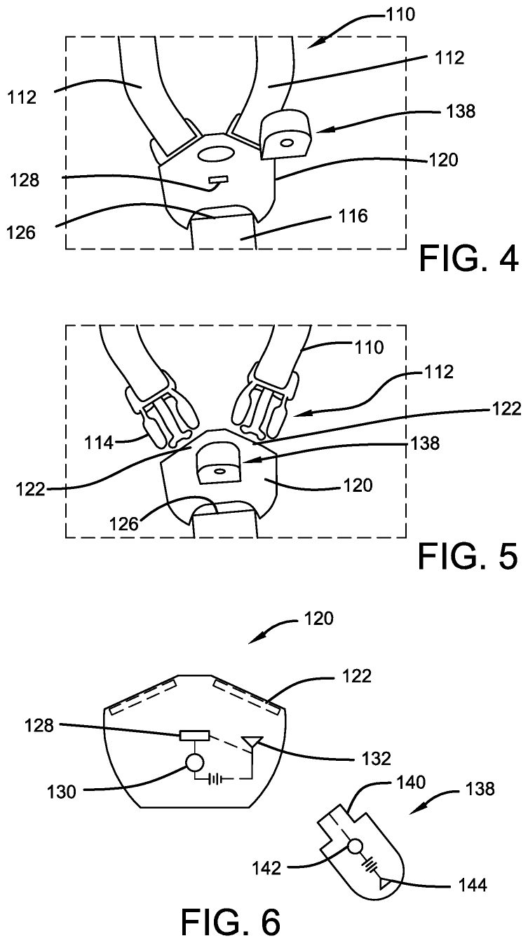

The child car seat 102 comprises a restraint component 110 adapted for use with the car seat 102. The restraint component 110 is typically a harness, such as a five-point harness or system of belts, latches, and buckles designed to hold the child or infant safely in the car seat 102. As illustrated in FIGS. 4 and 5, the restraint component 110 comprises a pair of shoulder and hip straps 112, a crotch strap 116, and a buckle 120. The buckle 120 is configured to secure the pair of shoulder and hip straps 112 to the crotch strap 114. The crotch strap 116 comprises a buckle attachment end 118 that is permanently attached to the buckle 120 via a crotch strap attachment element 126. The buckle 120 comprises a pair of female slots 122 for accepting a male buckle end 114 of each of the shoulder and hip straps 112. Each male buckle end 114 engages the corresponding female slot 122 to mechanically lock in place. Once each male buckle end 114 is engaged with the corresponding female slot 122, the restraint component 110 is in a locked position as illustrated in FIGS. 4 and 8.

As illustrated in FIG. 6, the child seat safety system 100 further comprises a fob mechanism 138. The fob mechanism 138 is configured to arm and disarm the buckle 120 of the restraint component 110. The fob mechanism 138 may be a key fob, such as a Bluetooth enabled USB or RFID enabled fob. The fob mechanism 138 comprises a buckle engaging element 140 for arming and disarming the buckle 120. The buckle engaging element 140 engages a arming and disarming receiving slot 128 of the buckle 120 as illustrated in FIGS. 5 and 9. The buckle engaging element 140 may be a USB type connector that engages the arming and disarming receiving slot 128 mechanically or electronically to arming and disarming the buckle 120.

The buckle 120 further comprises a buckle sensor 130. The buckle sensor 130 is a mechanical or electrical switch that detects when the buckle 120 is armed and disarmed. The buckle 120 further comprises a buckle transmitter 132 in electrical communication with the buckle sensor 130. The car seat 102 may further comprise a temperature sensor 136 to indicate a temperature of the surrounding environment as illustrated in FIG. 1. The temperature sensor 136 may be contained in the buckle 120 and configured to send an alert and/or a loud audible beeping from the keyfob when the temperature is a predetermined too high/too low.

As illustrated in FIG. 6, the fob mechanism 138 is in electrical communication with the buckle 120 of the restraint component 110 when the buckle 120 is armed. The fob mechanism 138 further comprises a fob mechanism transmitter 144 and a fob mechanism receiver 142. The fob mechanism receiver 142 is in electronic communication with the buckle transmitter 132. When the buckle sensor 130 detects that the buckle slot 128 is vacated, the buckle transmitter 132 transmits a signal to the fob mechanism receiver 142 indicating that the buckle 120 is armed. The fob mechanism transmitter 144 is typically a Bluetooth® transmitter. When the buckle sensor 130 detects that the buckle 120 is disarmed or the fob mechanism 128 is in the buckle slot 128, the buckle transmitter 132 stops transmitting the signal.

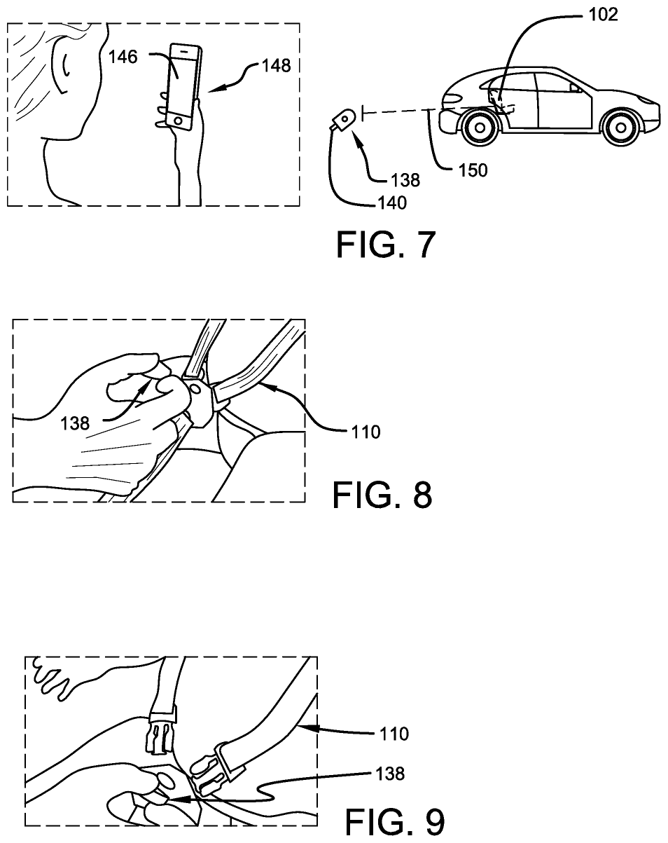

As illustrated in FIG. 7, the child seat safety system 100 further comprises a mobile application 146 storable on a mobile electronic device 148. The mobile application 146 is configured to receive an electronic communication from the fob mechanism 138 when the buckle 120 is armed once paired. The fob mechanism transmitter 144 sends the electronic communication to the mobile application 146 once the fob mechanism 138 is separated from the restraint component 110 by a preset distance 150 whenever the buckle 120 of the restraint component 110 is armed. Once the electronic communication is received, the mobile application 146 signals the user with an audible or digital alert indicating that a child has been inadvertently left alone in the locked car seat 102. The mobile application 146 can be programmed to sound continuously and only be silenced once the fob mechanism 130 is back within the preset distance 150 or once the restraint component 110 is disarmed.

The mobile electronic device 148 is a user interface such as, but not limited to, a mobile phone, a smart phone, a tablet, an iPad, or the like. The mobile electronic device 110 uses a processor to execute instructions that are stored in a memory. The memory comprises a non-transitory computer-readable medium comprising a set of software instructions that stores the mobile application 146. The set of software instructions allows the mobile electronic device 148 to perform methods of the present technology when executed by the processor.

It is contemplated that the child seat safety system 100 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

Notwithstanding the forgoing, the child seat safety system 100 of the present invention and its various structural components can be of any suitable size, shape, and configuration as is known in the art without affecting the overall concept of the invention, provided that it accomplishes the above stated objectives. One of ordinary skill in the art will appreciate that the shape and size of the child seat safety system 100 and its various components and material, as shown in the FIGS. are for illustrative purposes only, and that many other shapes and sizes of the child seat safety system 100 are well within the scope of the present disclosure. Although the dimensions of the child seat safety system 100 are important design parameters, the child seat safety system 100 and its components may be of any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A child seat safety system comprising:
a restraint component adapted for use with a car seat;
a fob mechanism for arming and disarming the restraint component; and
a mobile application for receiving an electronic communication from the fob mechanism and signaling a user.

2. The child safety system of claim 1, wherein the restraint component is a harness.

3. The child safety system of claim 1, wherein the restraint component comprises a pair of shoulder and leg straps, a crotch strap, and a buckle in electronic communication with the fob mechanism.

4. The child safety system of claim 3, wherein the fob mechanism comprises a buckle engaging element for arming and disarming the buckle.

5. The child safety system of claim 1, wherein the car seat is an infant carrier, a rear-facing car seat, a convertible seat, a combination car seat, or a booster seat.

6. The child safety system of claim 1, wherein the fob mechanism is in electronic communication with the buckle of the restraint component when the restraint component is armed.

7. The child safety system of claim 1, wherein the fob mechanism comprises a transmitter.

8. The child safety system of claim 1, wherein the fob mechanism is an RFID enabled key fob.

9. A child seat safety system comprising:
a car seat comprising a restraint component, the restraint component comprising a buckle;
a fob mechanism for arming and disarming the buckle of the restraint component; and
a mobile application for receiving an electronic communication from the fob mechanism and signaling a user once the fob mechanism is separated from the buckle by a preset distance while the buckle is armed.

10. The child seat safety system of claim 9, wherein the buckle comprises a Bluetooth transmitter.

11. The child seat safety system of claim 9, wherein the fob mechanism comprises a fob mechanism receiver in electronic communication with the buckle when the buckle is armed.

12. The child seat safety system of claim 9, wherein the mobile application signals the user with an audible or digital alert.

13. The child seat safety system of claim 12, wherein the audible alert can only be silenced by disarming the buckle with the fob mechanism.

14. The child seat safety system of claim 9, wherein the restraint component further comprises a harness.

15. The child seat safety system of claim 14, wherein the buckle comprises buckle transmitter for in electronic communication with the fob mechanism when the restraint component is armed.

16. A child seat safety system comprising:
a car seat comprising a restraint component comprising a buckle;
a fob mechanism for arming the buckle of the restraint component; and
a mobile application for receiving an electronic communication from the buckle and signaling a user once the fob mechanism is separated from the restraint component by a preset distance while the restraint component is armed.

17. The child seat safety system of claim 16, wherein the buckle comprises a buckle sensor for detecting when the buckle is armed.

18. The child seat safety system of claim 17, wherein buckle sensor is a mechanical switch.

19. The child seat safety system of claim 17, wherein the buckle sensor is an electronic switch.

20. The child seat safety system of claim 16, wherein the car seat further comprises a temperature sensor.
